(19) United States
(12) Patent Application Publication
(10) Pub. No.: US 2014/0362442 A1
(43) Pub. Date: Dec. 11, 2014

(54) TUNABLE OPTICAL FILTER

(71) Applicant: Zhuhai FTZ Oplink Communications, Inc., Zhuhai (CN)

(72) Inventors: Guoping Chen, Zhong Shan City (CN); Zhongsheng Wang, Zhong Shan City (CN); Yong Du, Zhuhai City (CN)

(73) Assignee: Zhuhai FTZ Oplink Communications, Inc., Zhuhai (CN)

(21) Appl. No.: 14/024,420

(22) Filed: Sep. 11, 2013

(30) Foreign Application Priority Data
Jun. 6, 2013 (CN) 201310224730.5

(51) Int. Cl. G02B 26/00

(52) U.S. Cl. CPC G02B 26/001
USPC 359/579; 359/578

(57) ABSTRACT

Methods, systems, and apparatus for optical fiber communications. One tunable optical filter includes a light inputting assembly and a light receiving assembly; an adjustable cavity length assembly arranged between the light inputting assembly and the light receiving assembly, wherein the adjustable cavity length assembly includes an adjustable length device, a first substrate, and a second substrate, wherein the first substrate and the second substrate are positioned parallel to each other and are fixed at respective ends of the adjustable length device; and a Fabry-Perot filter arranged in the adjustable cavity length assembly, the Fabry-Perot filter including a first component which is fixed on the first substrate, and a second component which is fixed on the second substrate, the first component includes a reflecting surface facing the second substrate and the second component includes a reflecting surface facing the first substrate.

### CROSS-REFERENCE TO RELATED APPLICATIONS

This application claims priority under 35 U.S.C. §119 to Chinese patent application 201310224730.5, filed Jun. 6, 2013, the disclosure of which is incorporated herein by reference.

### BACKGROUND

This specification relates to an optical device for an optical fiber communication system, and more specifically relates to a tunable optical filter.

With the development of optical fiber communication technology and sensor technology, sensor systems have typically been established using optical fibers and fiber grating sensors. The sensor systems scan and monitor wavelengths of laser beams reflected by the fiber grating sensors. In many conventional wavelength monitoring systems, tunable optical filters are used for filtering laser beams, such that laser beams of specific wavelength are output. For example, in Chinese patient application publication CN101604055A entitled “A duplex double-cavity adjustable optical fiber Fabry-Perot filter,” a filter is provided with two opposite supporting seats which are arranged in parallel. Piezoelectric ceramic is connected between the supporting seats. Two Fabry-Perot filters are fixed on the two supporting seats. Each Fabry-Perot filter includes tail fibers or optical fibers fixed on the two supporting seats. The end faces of the tail fibers or the optical fibers are coated with reflective films, so that laser beams can be reflected in a reciprocating way between the two reflective films. The distance between the two reflective films can be changed by adjusting the length of the piezoelectric ceramic, so that the central wavelengths of laser beams output by the Fabry-Perot filters are adjusted.

However, the filter requires fixing the tail fibers or optical fibers on the supporting seats, thus the manufacturing process is complex, and the production cost is high. Moreover, the tail fibers or optical fibers cannot be fixed relative to the supporting seats easily in the filter, which results in difficulty in adjusting the cavity lengths of the Fabry-Perot filters.

In Chinese patient application publication number CN1547048A entitled “A tunable Fabry-Perot cavity filter and a manufacturing method thereof” a filter is provided with a piezoelectric ceramic tube and a cylindrical shell sleeved outside the piezoelectric ceramic tube. Upper and lower ends of the cylindrical shell are provided with an upper cover and a lower cover respectively. One end of the piezoelectric ceramic tube is connected with the lower cover and parallel coated lenses are stuck to the other end of the piezoelectric ceramic tube and the upper cover, respectively. Additionally, the upper cover and the lower cover are provided with a light outlet hole and a light inlet hole, respectively. The outer walls of the upper cover and the lower cover are provided with respective collimating lenses and the collimating lenses are positioned in the light outlet hole and the light inlet hole. During operation of the filter, the distance between the two coated lenses is modified by changing the length of the piezoelectric ceramic tube so that the central wavelengths of laser beams output by the Fabry-Perot filter are adjusted.

However, the filter requires arranging the piezoelectric ceramic tube in a circular shell and forming the light inlet hole and the light outlet hole on the upper cover and the lower cover respectively, thus the manufacturing process is complex. Moreover, the process for attaching the coated lenses to the piezoelectric ceramic tube and the upper cover is complex, thus increasing production difficulty.

### SUMMARY

A tunable optical filter is disclosed that can be applied to a wavelength monitoring system and can be used for receiving laser beams, filtering laser beams, and outputting laser beams of specific wavelengths.

In general, one innovative aspect of the subject matter described in this specification can be embodied in tunable optical filters that include a light inputting assembly and a light receiving assembly; an adjustable cavity length assembly arranged between the light inputting assembly and the light receiving assembly, wherein the adjustable cavity length assembly includes an adjustable length device, a first substrate, and a second substrate, wherein the first substrate and the second substrate are positioned parallel to each other and are fixed at respective ends of the adjustable length device; and a Fabry-Perot filter arranged in the adjustable cavity length assembly, the Fabry-Perot filter including a first component which is fixed on the first substrate, and a second component which is fixed on the second substrate, the first component includes a reflecting surface facing the second substrate and the second component includes a reflecting surface facing the first substrate.

The foregoing and other embodiments can each optionally include one or more of the following features, alone or in combination. The second component comprises a second optical glass that is bonded on the second substrate and wherein the reflecting surface of the second component is the surface of the second optical glass facing the first substrate. The reflecting surface is a plane or a convex surface projecting towards the first substrate or a concave surface depressed towards the second substrate. The second substrate and the second optical glass are made of the same material. The second component is a high reflective film coated on the inner wall of the second substrate. The adjustable length device is made of piezoelectric ceramic. The adjustable length device is a hollow body of which the two ends are open and wherein the Fabry-Perot filter is positioned in the hollow body. The adjustable length device is a solid body, and the Fabry-Perot filter is positioned on one side of the adjustable length device. The first component includes a first optical glass which is bonded on the first substrate. The surface of the first optical glass facing the second substrate is planar. A surface of the first optical glass facing the second substrate is coated with a high-reflective film. The surface of the first optical glass facing the second substrate is a concave surface depressed toward the first substrate. The surface of the first optical glass facing the second substrate is a convex surface projecting towards the second substrate. The first substrate and the first optical glass are made of the same material. The adjustable length device is made from one of glass, silicon, or metal, and having an electro-thermal film attached to an outer surface.

Particular embodiments of the subject matter described in this specification can be implemented so as to realize one or more of the following advantages. A tunable optical filter is provided that is simple in structure, is manufactured with a simple production process, and is capable of high performance. A Fabry-Perot filter can be fixed in an adjustable cavity length assembly, so that the Fabry-Perot filter is not required to be constructed using optical fibers or tail fibers. Additionally, in some implementations, it is only required to fix a first optical glass on a first substrate and to fix a second component on a second substrate resulting in a simple production process of the tunable optical filter. Furthermore, the first optical glass can be fixed on the first substrate using optical contact bonding or using optical cement with a suitable gluing technique and the distance between the first optical glass and the first substrate can be fixed, which further results in the simple production process. Both high light transmittance and high performance can be achieved by the tunable optical filter.

In some implementations, the second component is provided with a second optical glass that is bonded on the second substrate using optical contact bonding or using optical cement with a suitable gluing technique, and the reflecting surface is the surface of the second optical glass facing the first substrate.

In some implementations, a second optical glass is fixed on a second substrate through optical contact bonding or through optical cement using a suitable gluing technique such that the distance between the second optical glass and the second substrate is fixed. This can ensure the performance of the tunable optical filter.

In some other implementations, having first and second substrates and first and second optical glasses, the first substrate and the first optical glass are made of the same material, and the second substrate and the second optical glass are made of the same material so that the optical glass can be fixed on the substrates using a suitable attachment technique such that the transmission of laser beams is facilitated.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an optical structural schematic diagram of a first example tunable optical filter.

FIG. 2 is an example frequency spectrum graph of laser beams received by a collimator during loading of different voltages through piezoelectric ceramic in the first tunable optical filter of FIG. 1.

FIG. 3 is an optical structural schematic diagram of a second example tunable optical filter.

FIG. 4 is an example frequency spectrum graph of laser beams received by a photo-diode during loading of different voltages through piezoelectric ceramic in the second tunable optical filter of FIG. 3.

FIG. 5 is an optical structural schematic diagram of a third example tunable optical filter.

FIG. 6 is an optical structural schematic diagram of a fourth example tunable optical filter.

FIG. 7 is an optical structural schematic diagram of a fifth example tunable optical filter.

FIG. 8 is an optical structural schematic diagram of a sixth example tunable optical filter.

FIG. 9 is an optical structural schematic diagram of a seventh example tunable optical filter.

FIG. 10 is an optical structural schematic diagram of an eighth example tunable optical filter.

Like reference numbers and designations in the various drawings indicate like elements.

### DETAILED DESCRIPTION

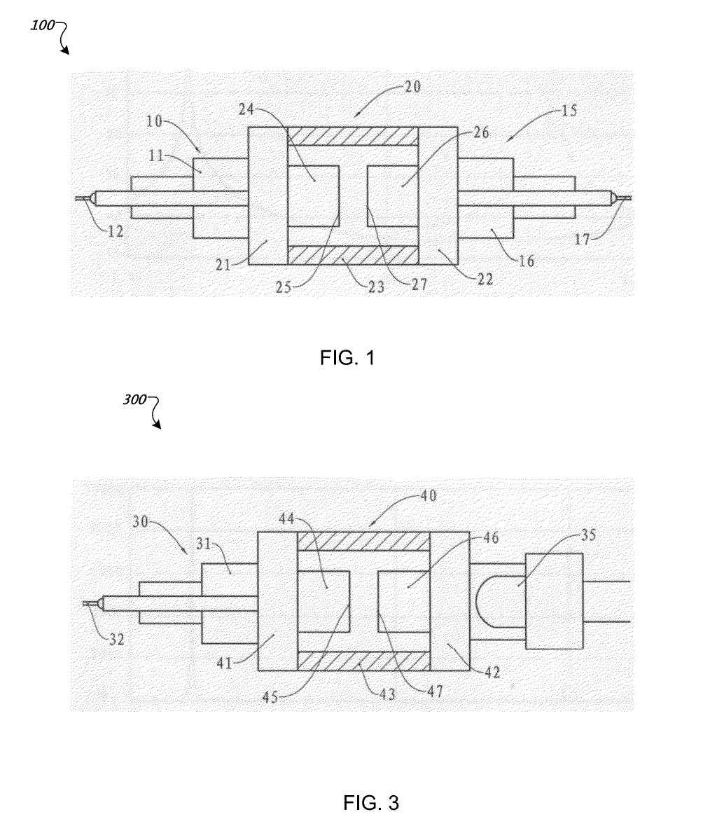

FIG. 1 is an optical structural schematic diagram of a first example tunable optical filter 100. The tunable optical filter 100 includes a light inputting assembly 10 and a light receiving assembly 15. An adjustable cavity length assembly 20 is arranged between the light inputting assembly 10 and the light receiving assembly 15.

The light inputting assembly 10 includes a single optical fiber collimator 11 with an optical fiber 12 arranged in the single optical fiber collimator 11. The light receiving assembly 15 includes a single optical fiber collimator 16 with an optical fiber 17 arranged in the single optical fiber collimator 16.

The adjustable cavity length assembly 20 includes two opposite substrates: a first substrate 21 and a second substrate 22. The first substrate 21 and the second substrate 22 are arranged in parallel with respect to each other. The light inputting assembly 10 is positioned on an outer side of the first substrate 21 and the light receiving assembly 15 is positioned on an outer side of the second substrate 22. An adjustable length device 23 is positioned on an inner side between the first substrate 21 and the second substrate 22. The adjustable length device 23 can be made of piezoelectric ceramic and can form a hollow cylinder in which the two ends of the cylinder are open. The inner side of the first substrate 21 and the second substrate 22 are fixed at the respective ends of the adjustable length device 23.

A Fabry-Perot filter is arranged in the adjustable cavity length assembly 20. The Fabry-Perot filter is formed from a first component and a second component. The first component includes a first optical glass 24, which is fixed on the inner side of the first substrate 21. The first optical glass 24 is fixed using optical contact bonding or using optical cement with suitable gluing or affixing techniques. The second component includes a second optical glass 26, which is fixed on the inner side of the second substrate 22. The second optical glass 26 is fixed using optical contact bonding or using optical cement with suitable gluing or affixing techniques. A surface 25 of the first optical glass 24 facing the second substrate 22 is a reflecting surface and is coated, e.g., with a high-reflective film. A surface 27 of the second optical glass 26 facing the first substrate 21 is also a reflecting surface and is coated, e.g., with a high-reflective film.

In some implementations, to better fix the first optical glass 24 on the first substrate 21, the first optical glass 24 and the first substrate 21 are composed of the same material. Thus, the first optical glass 24 can be firmly fixed on the first substrate 21 using e.g., optical contact bonding or optical cement. Likewise, the second optical glass 26 and the second substrate 22 are also made of the same material.

The surface 25 of the first optical glass 24 and the surface 27 of the second optical glass 26 are both planar. Thus, laser beams after entering the adjustable cavity length assembly 20 from the light inputting assembly 10, are reflected in a reciprocating manner between the surfaces 25 and 27 of the Fabry-Perot filter and undergo oscillation interference. The transmission intensity follows the following formula:

$${I}_{T} = \frac{1}{1 + \frac{4 R}{{( 1 - R )}^{2}} {sin}^{2} \frac{δ}{2}} {I}_{input} \qquad ( Formula 1 )$$

Where I_{T} is the transmission intensity, Iᵢₙₚᵤₜ is the input intensity, R is the reflectivity of the surfaces 25 and 27 of the Fabry-Perot filter, and δ is the phase difference between each succeeding reflection.

When

$$δ = \frac{4 π L cos {θ}_{0}}{λ} = 2 π k ,$$

where L is the length of the cavity between the first surface 25 and the second surface 27, a maximum value of light intensity will occur at a transmission end, namely, on the surface 27 of the second optical glass 26. Then, laser beams are emitted from the Fabry-Perot filter and are received by the light receiving assembly 15.

Consequently, since the adjustable length device 23 is piezoelectric, the cavity length of the Fabry-Perot filter can be modified by changing the voltage applied to the adjustable length device 23. Changing the length of the adjustable length device 23 changes the central wavelengths of the laser beams emitted from the adjustable cavity length assembly 20, thus allowing the wavelengths emitted to be controlled.

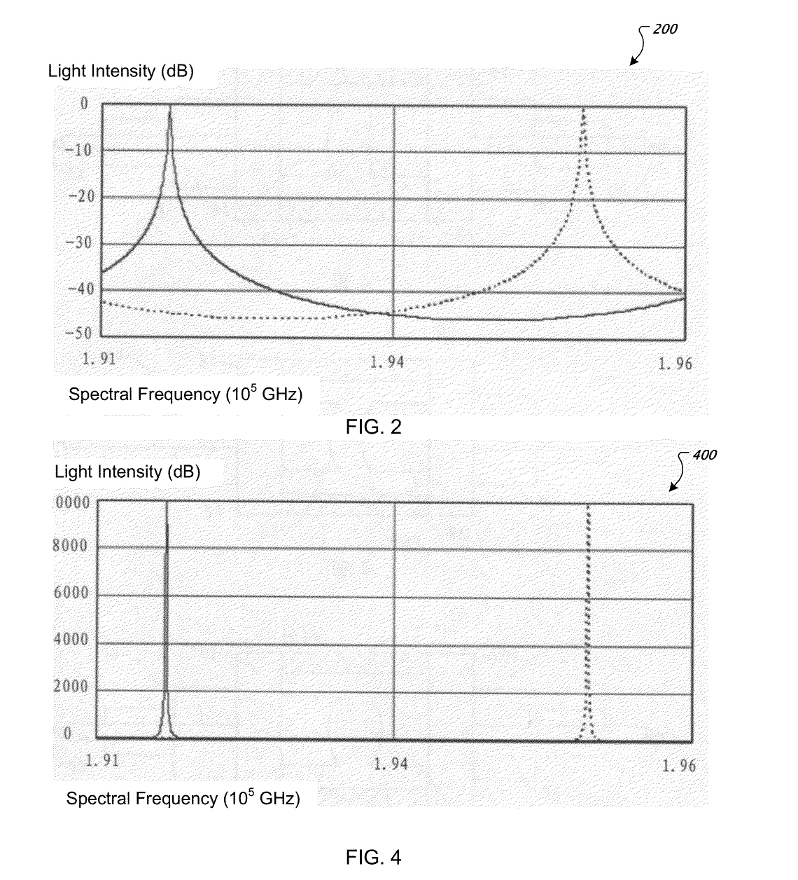

FIG. 2 is an example frequency spectrum graph 200 of laser beams received by a collimator during loading of different voltages through piezoelectric ceramic in the first tunable optical filter of FIG. 1. For example, the frequency spectrum of laser beams received by the single optical fiber collimator 16 of the light receiving assembly 15 during loading of different voltages signals. In particular, the example frequency spectrum graph 200 illustrates transmission light intensity with respect to frequency. In FIG. 2, solid lines show a spectrum graph during loading of high voltage while dotted lines show a spectrum graph during loading of low voltage. Thus different transmitted frequencies, corresponding to particular wavelengths, are possible based on different applied voltages.

Referring to FIG. 1, the first optical glass 24 and the second optical glass 26 are fixed on the first substrate 21 and the second substrate 22 using, for example, optical contact bonding or optical cement. The first optical glass 24 and the first substrate 21 are fixed firmly, and are prevented from moving relative to each other. The second optical glass 26 and the second substrate 22 are also fixed firmly.

FIG. 3 is an optical structural schematic diagram of a second example tunable optical filter 300. The tunable optical filter 300 includes a light inputting assembly 30 and a light receiving assembly 35. An adjustable cavity length assembly 40 is arranged between the light inputting assembly 30 and the light receiving assembly 35.

The light inputting assembly 30 includes a single optical fiber collimator 31 with an optical fiber 32 arranged in the single optical fiber collimator 31. The light receiving assembly 35 is a photodiode.

The structure of the adjustable cavity length assembly 40 is similar to that of the adjustable cavity length assembly 20 shown in FIG. 1. The adjustable cavity length assembly 40 includes with an adjustable length device 43. A first substrate 41 and a second substrate 42, arranged in parallel, are fixed at respective ends of the adjustable length device 43. In some implementations, the adjustable length device 43 is made of piezoelectric ceramic that forms a hollow body, e.g., cylindrical, having two open ends.

A first optical glass 44 is fixed on an inner wall of the first substrate 41 using optical contact bonding or optical cement with suitable gluing or affixing techniques. A surface 45 of the first optical glass 44, facing the second substrate 42, is planar and coated, e.g., with a high-reflective film.

A second optical glass 46 is fixed on an inner wall of the second substrate 42 using optical contact bonding or optical cement with suitable gluing or affixing techniques. A surface 47 of the second optical glass 46, facing the first substrate 41, is planar and coated, e.g., with a high-reflective film.

The length of the tunable optical filter 300 can be modified by changing the voltage applied to the adjustable length device 43 such that the distance between the surface 45 and the surface 47 is adjusted. Consequently, the central wavelengths of laser beams transmitted by the Fabry-Perot filter and received by the light receiving assembly 35 also change.

FIG. 4 is an example frequency spectrum graph 400 of laser beams received by a photodiode during loading of different voltages through piezoelectric ceramic in the second tunable optical filter of FIG. 3. For example, the frequency spectrum of laser beams received by the photodiode of the light receiving assembly 35 during loading of different voltages signals. In particular, the example frequency spectrum graph 400 illustrates transmission light intensity with respect to frequency. In FIG. 4 solid lines show a spectrum graph during loading of high voltage while dotted lines show a spectrum graph during loading of low voltage.

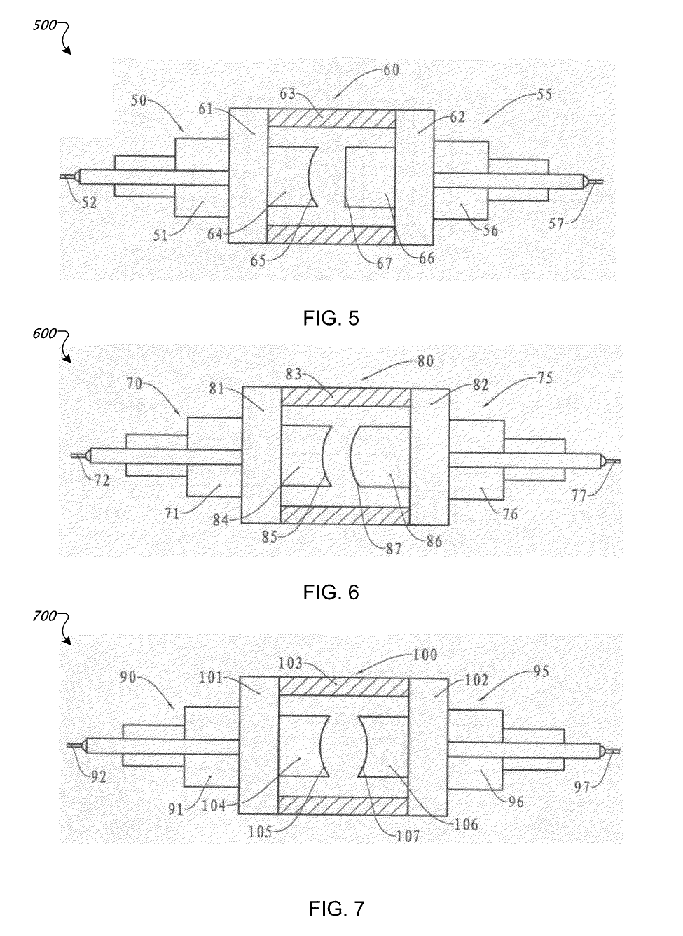

FIG. 5 is an optical structural schematic diagram of a third example tunable optical filter 500. The tunable optical filter 500 includes a light inputting assembly 50 and a light receiving assembly 55. An adjustable cavity length assembly 60 is arranged between the light inputting assembly 50 and the light receiving assembly 55.

The light inputting assembly 50 includes an optical fiber 52 and a single optical fiber collimator 51. The light receiving assembly 55 includes an optical fiber 57 and a single optical fiber collimator 56.

The adjustable cavity length assembly 60 includes a first substrate 61 and a second substrate 62. The first substrate and the second substrate are arranged in parallel. An adjustable length device 63 is positioned between the first substrate 61 and the second substrate 62. In particular, the first substrate 61 and the second substrate 62 are fixed at the respective ends of the adjustable length device 63. In some implementations, the adjustable length device 63 is formed from a hollow body, e.g., a cylinder, of glass. An electro-thermal film is attached to the outside of the glass. The electro-thermal film can be electrified to raise the temperature of the electro-thermal film such that the temperature of the glass serving as the adjustable length device 63 rises. As a result the length of the glass is controllably changed.

A first optical glass 64 is fixed on an inner wall of the first substrate 61 using optical contact bonding or optical cement with suitable gluing or affixing techniques. A surface 65 of the first optical glass 64 facing the second substrate 62 is a concave surface depressed toward the first substrate 61 and is coated, e.g., with a high-reflective film. A second optical glass 66 is also fixed on an inner wall of the second substrate 62 using optical contact bonding or optical cement with suitable gluing or affixing techniques. A surface 67 of the second optical glass 66 facing the first substrate 61 is a planar reflecting surface coated e.g., with a high-reflective film.

A distance between the surface 65 and the surface 67 of the first and second optical glass 64 and 66 can be changed by changing the length of the adjustable length device 63 so that the interference central wavelengths of laser beams transmitted by the Fabry-Perot filter and received by the light receiving assembly 55 are controllably changed.

FIG. 6 is an optical structural schematic diagram of a fourth example tunable optical filter 600. The tunable optical filter 600 includes a light inputting assembly 70 and a light receiving assembly 75. An adjustable cavity length assembly 80 is arranged between the light inputting assembly 70 and the light receiving assembly 75.

The light inputting assembly 70 includes an optical fiber 72 and a single optical fiber collimator 71. The light receiving assembly 75 includes an optical fiber 77 and a single optical fiber collimator 76.

The adjustable cavity length assembly 80 includes an adjustable length device 83. In some implementations, the adjustable length device 83 is a piezoelectric ceramic formed as a hollow body, e.g., a cylindrical body, having two open ends, e.g., opposite ends. A first substrate 81 and a second substrate 82 are respectively fixed at the two ends of the adjustable length device 83. A first optical glass 84 is fixed on an inner wall of the first substrate 81 using optical contact bonding or optical cement with suitable gluing or affixing techniques. A surface 85 of the first optical glass 84 facing the second substrate 82 is a reflecting surface that is coated e.g., with a high-reflective film. A second optical glass 86 is fixed on an inner wall of the second substrate 82 using optical contact bonding or optical cement with suitable gluing or affixing techniques. A surface 87 of the second optical glass 86 facing the first substrate 81 is also a reflecting surface coated e.g., with a high-reflective film.

The surface 85 of the first optical glass 84 is a concave surface depressed toward the first substrate 81. The surface 87 of the second optical glass 86 is a convex surface projecting towards the first substrate 81. During operation of the tunable optical filter 600, a distance between the surfaces 85 and 87 of the first and second optical glass 84 and 86 can be modified by changing the length of the adjustable length device 83 in a similar manner as described above with respect to FIG. 1, thus the central wavelengths of laser beams transmitted by the Fabry-Perot filter and received by the light receiving assembly 75 can be controllably changed.

FIG. 7 is an optical structural schematic diagram of a fifth example tunable optical filter 700. The tunable optical filter 700 includes a light inputting assembly 90 and a light receiving assembly 95. An adjustable cavity length assembly 100 is arranged between the light inputting assembly 90 and the light receiving assembly 95.

The light inputting assembly 90 includes an optical fiber 92 and a single optical fiber collimator 91. The light receiving assembly 95 includes an optical fiber 97 and a single optical fiber collimator 96.

The adjustable cavity length assembly 100 includes an adjustable length device 103. In some implementations, the adjustable length device 103 is a piezoelectric ceramic formed as a hollow body, e.g., a cylindrical body, having two opening ends, e.g., opposite ends. A first substrate 101 and a second substrate 102 are respectively fixed at the two ends of the adjustable length device 103. A first optical glass 104 is fixed on an inner wall of the first substrate 101 using optical contact bonding or optical cement with suitable gluing or affixing techniques. A surface 105 of the first optical glass 104 facing the second substrate 102 is a reflecting surface coated, e.g., with a high-reflective film. A second optical glass 106 is fixed on an inner wall of the second substrate 102 using optical contact bonding or optical cement with suitable gluing or affixing techniques. A surface 107 of the second optical glass 106 facing the first substrate 101 is also a reflecting surface coated, e.g., with a high-reflective film.

The surface 105 of the first optical glass 104 is a concave surface depressed toward the first substrate 101. The surface 107 of the second optical glass 106 is a concave surface depressed towards the second substrate 102. During operation of the tunable optical filter 700, a distance between the surfaces 105 and 107 of the first and second optical glass 104 and 106 can be modified by changing the length of the adjustable length device 103 as described above. Thus the interference central wavelengths of laser beams transmitted by the Fabry-Perot filter and received by the light receiving assembly 95 can be controllably changed.

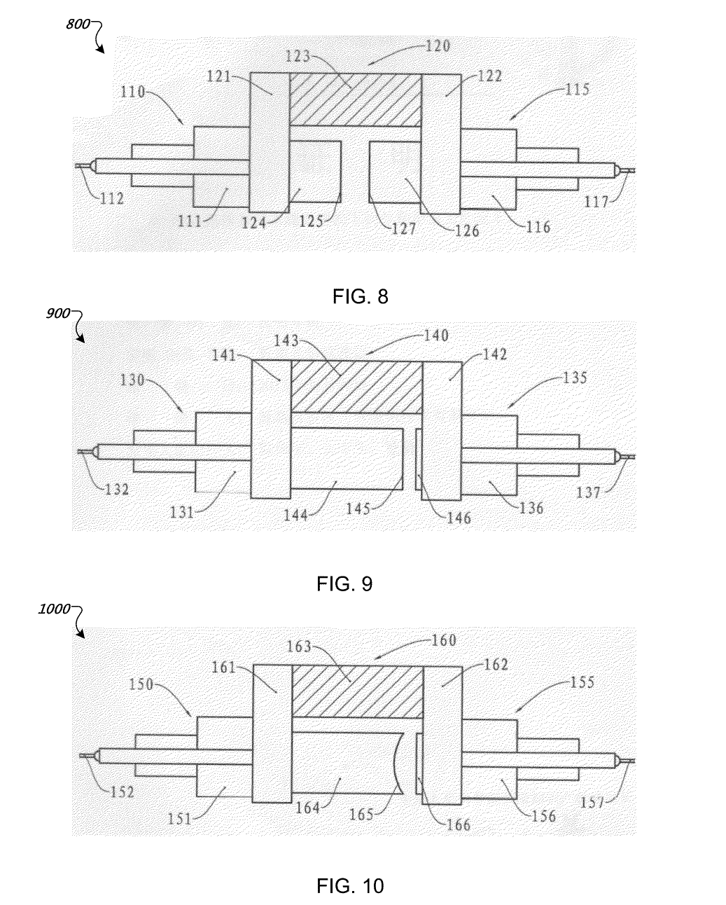

FIG. 8 is an optical structural schematic diagram of a sixth example tunable optical filter 800. The tunable optical filter 800 includes a light inputting assembly 110 and a light receiving assembly 115. An adjustable cavity length assembly 120 is arranged between the light inputting assembly 110 and the light receiving assembly 115.

The light inputting assembly 110 includes an optical fiber 112 and a single optical fiber collimator 111. The light receiving assembly 115 includes an optical fiber 117 and a single optical fiber collimator 116.

The adjustable cavity length assembly 120 includes an adjustable length device 123. In some implementations, the adjustable length device 123 is a rectilinear solid body. In some implementations, the rectilinear solid body is square. A first substrate 121 and a second substrate 122, which are arranged in parallel, are fixed, respectively, at two ends of the adjustable length device 123. Additionally, a Fabry-Perot filter is arranged in the adjustable cavity length assembly 120 and is positioned on one side adjacent to the adjustable length device 123.

The Fabry-Perot filter includes a first component which is fixed on the first substrate 121 and a second component which is fixed on the second substrate 122. The first component can be a first optical glass 124 that is fixed on the inner wall of the first substrate 121 using optical contact bonding or optical cement with suitable gluing or affixing techniques. A surface 125 of the first optical glass 124 facing the second substrate 122 is a reflecting surface is planar and coated, e.g., with a high-reflective film. The second component can be a second optical glass 126 that is fixed on the second substrate 122 using optical contact bonding or optical cement with suitable gluing or affixing techniques. A surface of the second optical glass 126 facing the surface 127 of the first substrate 121 is a reflecting surface that is planar and is coated, e.g., with a high-reflective film.

A length of the adjustable length device 123 can be modified by adjusting voltage loaded onto the piezoelectric ceramic serving as the adjustable length device 123. As a result, the distance between the surface 125 and the surface 127 is changed so that the interference central wavelengths of laser beams transmitted by the Fabry-Perot filter and received by the light receiving assembly 115 can be controllably changed.

FIG. 9 is an optical structural schematic diagram of a seventh example tunable optical filter 900. The tunable optical filter 900 includes a light inputting assembly 130 and a light receiving assembly 135. An adjustable cavity length assembly 140 is arranged between the light inputting assembly 130 and the light receiving assembly 135.

The light inputting assembly 130 includes an optical fiber 132 and a single optical fiber collimator 131. The light receiving assembly 135 is provided with an optical fiber 137 and a single optical fiber collimator 136.

The adjustable cavity length assembly 140 includes an adjustable length device 143. In some implementations, the adjustable length device 143 is a rectilinear, e.g., square, solid body. A first substrate 141 and a second substrate 142, which are arranged in parallel, are fixed, respectively, at the two ends of the adjustable length device 143. Additionally, a Fabry-Perot filter is arranged in the adjustable cavity length assembly 140 and is positioned on one side adjacent the adjustable length device 143.

The Fabry-Perot filter includes a first component which is fixed on the first substrate 141 and a second component which is fixed on the second substrate 142. The first component can be a first optical glass 144 that is fixed on an inner wall of the first substrate 141 using optical contact bonding or optical cement with suitable gluing or affixing techniques. A surface 145 of the first optical glass 144 facing the second substrate 142 is a reflecting surface that is planar and coated, e.g., with a high-reflective film. The second component can be a high-reflective film 146 coated on the second substrate 142 so that the surface of the high-reflective film 146 facing the first substrate 141 is a reflecting surface.

A length of the adjustable length device 143 can be modified by adjusting a voltage loaded onto a piezoelectric ceramic serving as the adjustable length device 143. As a result, the distance between the surface 145 of the first optical glass 144 and the high-reflective film 146 is changed so that the interference central wavelengths of laser beams transmitted by the Fabry-Perot filter and received by the light receiving assembly 135 can be controllably changed.

FIG. 10 is an optical structural schematic diagram of an eighth example tunable optical filter 1000. The tunable optical filter 1000 includes a light inputting assembly 150 and a light receiving assembly 155. An adjustable cavity length assembly 160 is arranged between the light inputting assembly 150 and the light receiving assembly 155.

The light inputting assembly 150 includes an optical fiber 152 and a single optical fiber collimator 151. The light receiving assembly 155 includes an optical fiber 157 and a single optical fiber collimator 156.

The adjustable cavity length assembly 160 includes an adjustable length device 163. In some implementations, the adjustable length device 163 is a rectilinear, e.g., square, solid body. A first substrate 161 and a second substrate 162, which are arranged in parallel, are fixed, respectively, at two ends of the adjustable length device 163. Additionally, a Fabry-Perot filter is arranged in the adjustable cavity length assembly 160 and is positioned on one side adjacent to the adjustable length device 163.

The Fabry-Perot filter includes a first component which is fixed on the first substrate 161 and a second component which is fixed on the second substrate 162. The first component can be a first optical glass 164 that is fixed on an inner wall of the first substrate 161 using optical contact bonding or optical cement with suitable gluing or affixing techniques. A surface 165 of the first optical glass 164 facing the second substrate 162 is a reflecting surface that is coated, e.g., with a high-reflective film and that is a concave surface depressed towards the first substrate 161. The second component can be a high-reflective film 166 coated on the second substrate 162 so that the surface of the high-reflective film 166 facing the first substrate 161 is a reflecting surface.

A length of the adjustable length device 163 can be modified by adjusting a voltage loaded onto a piezoelectric ceramic serving as the adjustable length device 163. As a result, the distance between the surface 165 of the first optical glass 164 and the high-reflective film 166 is changed so that the interference central wavelengths of laser beams transmitted by the Fabry-Perot filter and received by the light receiving assembly 155 can be controllably changed.

The example tunable optical filters described above are only example implementations. Other implementations are possible. For example, instead of an optical glass, the first component can include a high reflective film affixed to the first substrate. In another example, the light receiving assemblies can be replaced by photodiodes in each of the above example implementations. In the tunable optical filter 1000 of FIG. 10, the surface of the optical glass can be a convex surface projecting towards the second substrate. In some implementations, the adjustable length device can be replaced by other materials for example, silicon or metal. An electro-thermal film is attached to the silicon or metal, and the temperature of the electro-thermal film rises by electrifying, so that the length of the adjustable length device is changed. Furthermore, any solid material with high thermal expansion coefficient and suitable mechanical properties, such as the hardness, etc. could be used for the adjustable length device along with the glass, silicon or metal.

In some other implementations, the surface of the optical glass fixed on the first substrate is set as a convex surface projecting towards the second substrate and the surface of the optical glass fixed on the second substrate is set into a concave surface depressed toward the second substrate. Changes such as the change of the surface shape of the optical glass, changes of the optical glass, and a substrate material are also contemplated.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A tunable optical filter, comprising:
a light inputting assembly and a light receiving assembly;
an adjustable cavity length assembly arranged between the light inputting assembly and the light receiving assembly, wherein the adjustable cavity length assembly includes an adjustable length device, a first substrate, and a second substrate, wherein the first substrate and the second substrate are positioned parallel to each other and are fixed at respective ends of the adjustable length device; and
a Fabry-Perot filter arranged in the adjustable cavity length assembly, the Fabry-Perot filter including a first component which is fixed on the first substrate, and a second component which is fixed on the second substrate, the first component includes a reflecting surface facing the second substrate and the second component includes a reflecting surface facing the first substrate.

2. The tunable optical filter of claim 1, wherein the second component comprises a second optical glass that is bonded on the second substrate and wherein the reflecting surface of the second component is the surface of the second optical glass facing the first substrate.

3. The tunable optical filter of claim 2, wherein the reflecting surface is a plane or a convex surface projecting towards the first substrate or a concave surface depressed towards the second substrate.

4. The tunable optical filter of claim 2, wherein the second substrate and the second optical glass are made of the same material.

5. The tunable optical filter of claim 1, wherein the second component is a high-reflective film coated on the inner wall of the second substrate.

6. The tunable optical filter of claim 1, wherein the adjustable length device is made of piezoelectric ceramic.

7. The tunable optical filter of claim 1, wherein the adjustable length device is a hollow body of which the two ends are open and wherein the Fabry-Perot filter is positioned in the hollow body.

8. The tunable optical filter of claim 1, wherein the adjustable length device is a solid body, and the Fabry-Perot filter is positioned on one side of the adjustable length device.

9. The tunable optical filter of claim 1, wherein the first component includes a first optical glass which is bonded on the first substrate.

10. The tunable optical filter of claim 9, wherein the surface of the first optical glass facing the second substrate is planar.

11. The tunable optical filter of claim 9, wherein a surface of the first optical glass facing the second substrate is coated with a high-reflective film.

12. The tunable optical filter of claim 9, wherein the surface of the first optical glass facing the second substrate is a concave surface depressed toward the first substrate.

13. The tunable optical filter of claim 9, wherein the surface of the first optical glass facing the second substrate is a convex surface projecting towards the second substrate.

14. The tunable optical filter of claim 1, wherein the first substrate and the first optical glass are made of the same material.

15. The tunable optical filter of claim 1, wherein the adjustable length device is made from one of glass, silicon, or metal, and having an electro-thermal film attached to an outer surface.
